(19) United States
(12) Patent Application Publication
(10) Pub. No.: US 2004/0243828 A1
(43) Pub. Date: Dec. 2, 2004

(54) Method and system for securing block-based storage with capability data

(76) Inventors: Marcos K. Aguilera, Palo Alto, CA (US); Minwen Ji, Sunnyvale, CA (US); Mark Lillibridge, Mountain View, CA (US); John Philip MacCormick, San Francisco, CA (US); Erwin Oertli, Mountain View, CA (US); David Godbe Andersen, Cambridge, MA (US); Michael Burrows, Palo Alto, CA (US); Timothy P. Mann, Redwood City, CA (US); Chandramohan A. Thekkath, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/449,576

(22) Filed: May 30, 2003

(51) Int. Cl. H04L 9/00

(52) U.S. Cl. 713/200

(57) ABSTRACT

A system for protecting data integrity in a network attached block-device, such as a disk or a disk array, includes a capability issuer module coupled to a metadata server. The capability-issuer module creates capability data in accordance with a predetermined set of rules, and issues the capability data to the client over a secured channel. The capability data includes a group identifier, a capability identifier, a block-device identifier, a list of extents for specifying a range of blocks to which access is granted, an access mode for indicating the type of access allowed, and a cryptographic string for preventing forgery of capabilities by unauthorized parties. A capability checker module coupled to a network attached block-device verifies that the client's block access request is consistent with the capability data issued, and that the capability data is authentic. Upon verifying the client's capability data, the client's block access request is granted and executed at the network-attached block-device.

### RELATED APPLICATIONS

This application is related to a patent application entitled Method and System for Managing Access Control, Ser. No. 10/______, filed on ______, Attorney Docket 9772-0347-999, which is hereby incorporated by reference.

### FIELD OF THE INVENTION

The present invention relates to the fields of computer data storage and computer security. In particular, the invention relates to a method and system for securing block-based storage with capability data.

### BACKGROUND OF THE INVENTION

Block-based storage devices store and retrieve data upon request. Such devices manage a set of blocks, each of which can store data. Each block is identified by a label (e.g., a number). “Write” requests store data and “read” requests retrieve data. Unlike file-based storage devices, block-based storage devices do not attempt to maintain the ownership of the data in each block. Examples of block-based storage devices include disks, disk arrays, and tape. Block-based storage devices are also referred to as “block-devices”.

FIG. 1 illustrates a typical block-based file system. In this block-based file system, clients 102 make file requests over an interconnect 104 to a file server 106, which in turn makes block requests to block-devices 108 such as disks or disk arrays. As the number of clients 102 increase, the load on the block-devices 108 increases as well, which causes the performance of the file system to degrade, particularly in terms of latency and per-client throughput. To keep up with performance, one approach is to add more block-devices while ensuring that the data (and hence the load) are spread evenly across the block-devices. However, this solution does not scale, because as traffic increases, the file server 106 eventually gets overloaded and becomes a performance bottleneck. In addition, if the file server 106 fails, all data becomes unavailable.

FIG. 2 illustrates a network file system that provides a solution to the problems of the distributed file system of FIG. 1. This is accomplished by attaching disks or other block-devices directly to the network, such as to a storage area network. As shown in FIG. 2, the network includes a group of clients 202, a group of block-devices 208 such as disks, and one or more metadata servers 206, all connected together via some interconnect 204, such as Gigabit Ethernet or Fibre Channel. The metadata server 206 is removed from the critical data path. Clients 202 can access the block-devices 208 directly without going through the metadata server 206. To access data, a client contacts a metadata server once, in order to know where to find the data on the block-devices; afterwards, the client accesses the block-devices directly by issuing (directly to the block-devices) low-level read and write requests for blocks of data. In this way, the metadata server 206 is no longer a performance bottleneck and the system scales much better. In addition, when the metadata server 206 fails, it can be replaced by another server in the network, so that data continue to be available.

The system of FIG. 2, with block-devices attached directly to the network, scales very well with the number of clients as there is no longer a server bridging between the clients and the block-devices. However, the system of FIG. 2 has a serious security problem because every client has full access to all the block-devices on the network. FIG. 3 illustrates a security problem with the block-based file system in FIG. 2. As shown in FIG. 3, every client has complete access to the data in the block-devices. There are a number of ways that the data in the network attached block-devices 208 may be compromised or destroyed. First, a hacker 302 who gains illegal access to the network may issue a malicious write 304 to the block-devices. Second, a client 202 who has legal access to the network may issue a malicious write 306 to the block-devices. Third, a client 202 may issue an erroneous write 308 to the block-devices.

There are existing mechanisms for keeping malicious parties from issuing any block-device access requests by denying access to the I/O bus or to the network. However, such mechanisms are applied outside of the block-device and they do not work if a malicious party gains direct access to the network. For example, as shown in FIG. 3, a malicious party such as a hacker 302 may be able to connect to the network at some point in the shared communication medium, and thereby gain access to the block-device. Thus, there is a need for a mechanism for protecting data integrity of block-devices that are attached directly to the network.

One way to protect the block-devices is to check the client request in the client kernels, before the request is sent to the block-device. The block-device simply assumes that incoming requests have already been cleared by the client kernels. This solution is not satisfactory for two reasons. First, it may not be reasonable to assume that the client kernels are trustworthy. In fact, in many networks, users have physical access to their desktop machines and it is not hard for the users to modify the kernel to bypass the security mechanism. Second, even if client kernels are trustworthy, the existing solution requires the network medium, such as cables, to be physically secured so that intruders cannot hook up to the network and issue destructive requests to the block-devices. In many cases, securing the network medium may be enormously difficult (e.g., wireless networks) or prohibitively expensive (e.g., securing all network cables).

In view of the shortcomings of the prior art, it is an objective of the present invention to provide a mechanism to prevent malicious overwrite of data in the block-devices by an unauthorized user on the network. It is another objective of the present invention to provide a mechanism to prevent malicious or erroneous overwrite of data in the block-devices by a client which is not authorized to do so. More generally, it is an objective of the present invention to provide a mechanism within the block-device so that data is secure despite clients and malicious parties attempting to get unauthorized access the data.

### SUMMARY OF THE INVENTION

A system for protecting data integrity in a network attached block-device includes at least one metadata server and at least one block-device attached to the network. The metadata server has one or more processing units for executing computer programs, and one or more network interfaces for exchanging information with devices coupled to the network. The network-attached block-device also has one or more processing units for executing computer programs, and one or more network interfaces for exchanging information with devices coupled to the network. The block-device stores data in a range of data blocks.

The metadata server has, or is coupled to, a capability issuer module for receiving from a client a request to access data or parts of data, determining if the client is permitted to access the data, and if the client is permitted to access the data, issuing a block-device access package containing capability data to the client over a secure channel. The capability data identifies a range of blocks in the network attached device corresponding to the data that the client wishes to access. The network attached block-device includes a capability checker module for receiving a block access request from the client, the request including the capability data; verifying that the block access request is consistent with the capability data; and if the block access request is verified, granting the block access request and executing the block access request at the network attached block-device.

A method for protecting data integrity in a network attached block-device includes receiving from a client a data access request, determining if the client is permitted to access the data, and if the client is permitted to access the data, issuing a block-device access package containing capability data to the client over a secure channel, the capability data identifying a range of blocks in the network attached block-device corresponding to the data that the client wishes to access. At the network attached block-device, the method includes receiving a block access request from the client, the request including the capability data, verifying that the block access request is consistent with the capability data, and if the block access request is verified, granting the block access request and executing the block access request at the network attached block-device.

### BRIEF DESCRIPTION OF THE DRAWINGS

The aforementioned features and advantages of the invention as well as additional features and advantages thereof will be more clearly understood hereinafter as a result of a detailed description of preferred embodiments of the invention when taken in conjunction with the following drawings.

FIG. 1 illustrates a traditional distributed file system.

FIG. 2 illustrates a system where block-devices are attached directly to the network.

FIG. 3 illustrates a security problem with the system of FIG. 2.

FIG. 4 illustrates a mechanism that uses capability data to protect data integrity of block-devices attached directly to the network

FIG. 5 illustrates the data structure of an exemplary capability data.

FIG. 6 illustrates a message authentication code (MAC) scheme used to ensure that only authorized parties can issue capabilities.

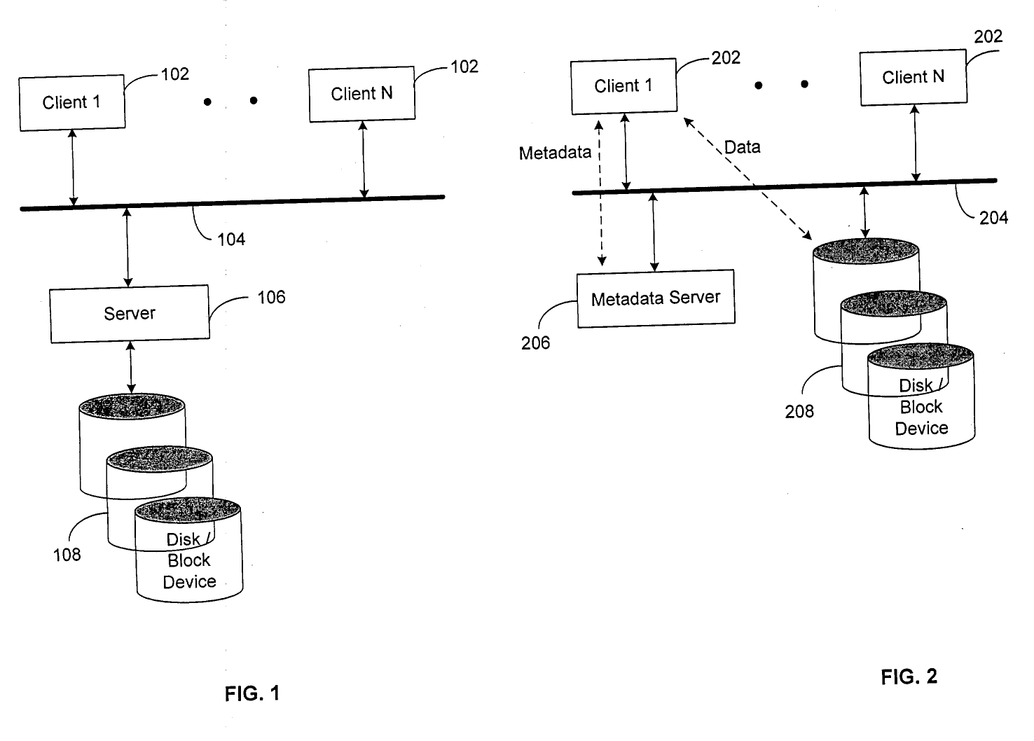

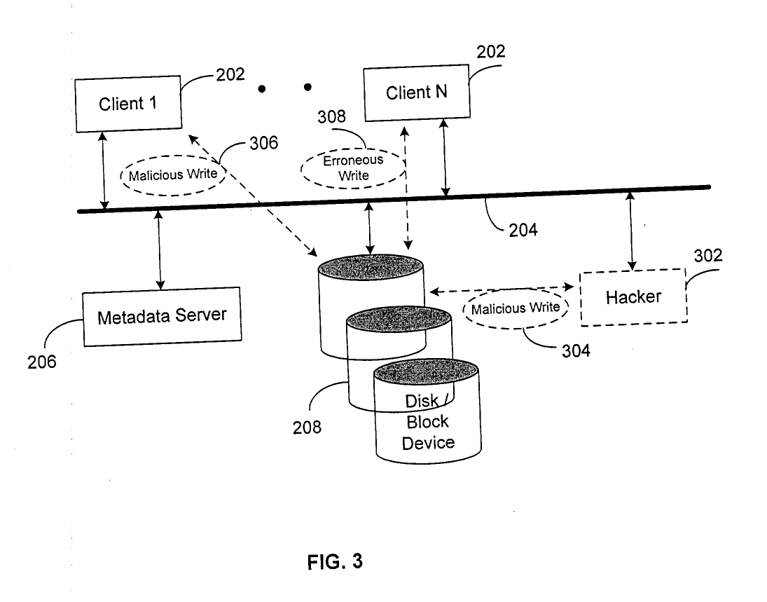

### DESCRIPTION OF THE PREFERRED EMBODIMENTS

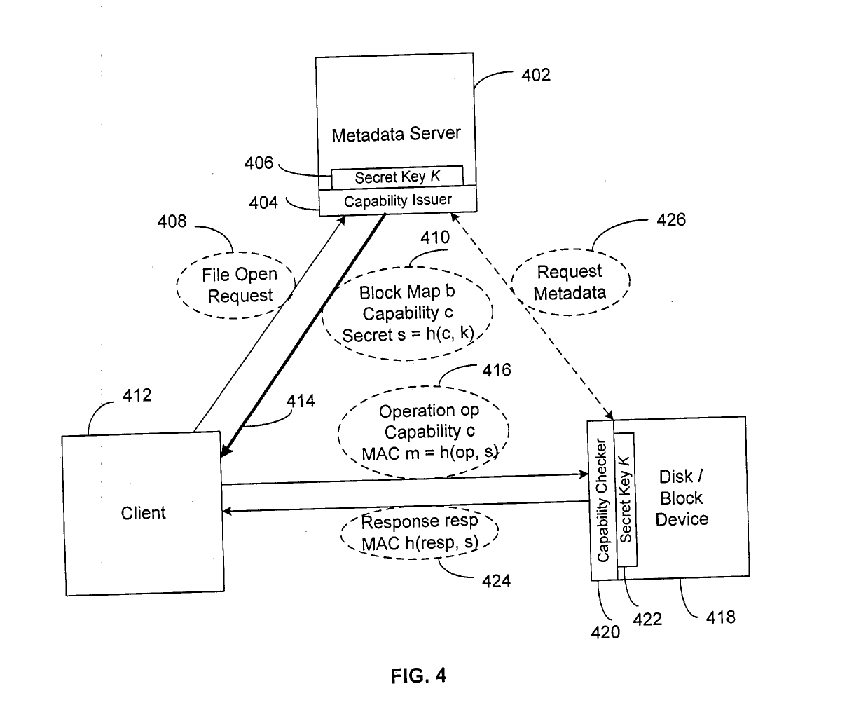

FIG. 4 illustrates a mechanism that uses capability data for protecting data integrity of block-devices that are attached directly to the network. A metadata server 402 includes a capability issuer 404 for creating and issuing capability data. The metadata server further includes a secret key k 406 for generating authentication information for the capability data. A block-device 418 includes a capability checker 420 for verifying the validity of capability data submitted by the client 412. The block-device further includes a secret key k 422, which is the same secret key as the one in the metadata server.

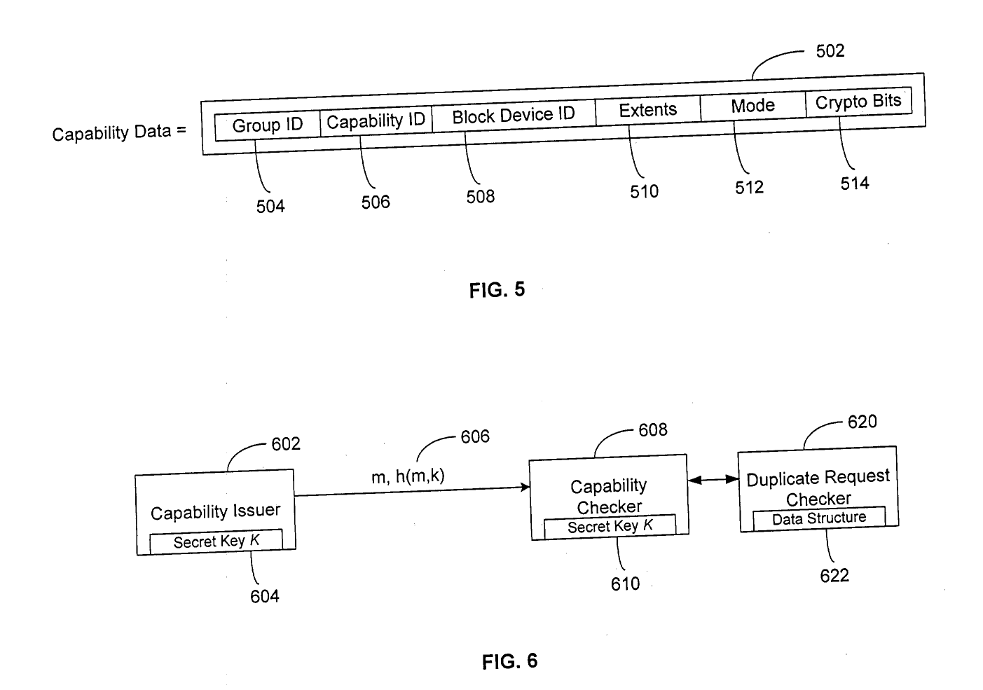

FIG. 5 illustrates a data structure 502 for representing capability data in accordance with an embodiment of the present invention. This data structure 502 is sometimes called a capability certificate. The data structure or certificate 502 represents a capability that has been granted to at least one client or user in the network. The capability data 502 includes a group identifier 504, a capability identifier 506, a block-device identifier 508 for specifying the block-device to which the capability applies, a list of extents 510 for specifying a range of blocks to which access is granted, an access mode 512 for indicating the type of access as read, write or both, and a cryptographic string 514 such as a signature for preventing forgery of capabilities by unauthorized parties. Capabilities grant specified types of access to specified blocks stored within a block-device 418 (FIG. 4). They are attached to requests sent by a client 412 to the block-device 418. When the client 412 wishes to read or write data, it issues a block request to the block-device 418, accompanied by the appropriate capability. Upon receiving the block request, the capability checker 420 verifies that the capability data submitted is valid, and only in that case does the block-device 418 execute the block request.

Note that the mechanism in the present disclosure is independent of which policies are used to control access to data. Such policies are usually determined by an operating system, which may use conventional or other mechanisms to organize data storage within the system and to decide which clients, processes, and the like have access to what data. Often times, an operating system organizes data through files. It assigns each file to an owner (a concept defined by the operating system) and to certain specifications in which users are given certain type of access to the file. The mechanisms and method of the present invention work at a lower level, in which there is no notion of ownership or of access policies. As a result, these mechanisms and methods work with any access policy. In addition, a capability checker is inserted between the block-device's communication port and the outside world, so that industry-standard block-devices can be used without having to modify the design of such devices.

Capabilities are issued by authorized parties only. Standard cryptographic techniques may be used to ensure that other parties are incapable of issuing capabilities. FIG. 6 illustrates a method to prevent forgery of capabilities, using message authentication codes (MAC). In FIG. 6, the capability checker 608 stores a secret key k 610, which is made known to the authorized capability issuer 602. The secret key may be established when the block-device and the capability checker are initially set up, as follows. Upon initial installation, the capability checker 608 starts in a special state, in which it trusts the first party that communicates with it. The capability checker 608 negotiates its secret key with that party, using a standard key exchange algorithm, such as Diffie-Hellman, and the party effectively becomes an authorized capability issuer 602. From that point on, the capability checker 608 only accepts capabilities that bear a message authentication code (MAC) that is consistent with the secret key 610. Although not shown in FIG. 6, the capability and the MAC for the capability are initially provided to a client (not shown in FIG. 6), which then passes those parameters to the capability checker for a block device when submitting an access request to the block device.

As shown in FIG. 6, the message authentication code h(m,k) 606 is generated using a keyed-hash message authentication code function h. Function h(data, key) returns a string mac of fixed length with the following property: without knowing the value of the secret key k 604 and 610, it is infeasible to find any new pairs of mac′ and data′ such that mac′ =h(data′, key). Unlike public-key signatures, MAC functions can be computed quite efficiently in practice. For increased security, the secret key k 604 and 610 should be considerably long (e.g., having at least 512 bits). However, having long keys can impact performance. To achieve a good tradeoff, in an alternative implementation, a small session key (e.g., having no more than 64 bits) is derived from a long key periodically and is used as the secret key k. This small session key typically expires after a predetermined period of time.

FIG. 6 also shows an optional duplicate request checker 620, which may be implemented as part of the capability checker or separately. The role of the duplicate request checker 620 is to prevent a hacker or unauthorized client from making a copy of the access request by another (authorized) client and resubmitting that request to the block device so as to obtain unauthorized access to same data as the authorized client. A detected duplicate request is rejected, even when the capability embedded in the request is determined to be valid. A number of different techniques can be used to detect duplicate requests, and a detailed description of those is beyond the scope of this document. As with capability checks, duplicate detection checks must be simple to perform, with minimal computational resources. Also, the duplicate request checker must distinguish between duplicate requests by an authorized client and unauthorized duplicate requests. In one implementation, the duplicate request checker 620 storing information in a compact data structure 622 about recent requests and the clients who made those requests, and performs checks against that data structure to detect duplicate requests. The data structure 622 may be a Bloom filter. To avoid overflowing the data structure 622 with information about requests, N (e.g., three or more) data structures 622 may be used, each used to store information for all requests since it was last emptied. Upon expiration of each successive epoch, a next one of the data structures (e.g., Bloom filters) is deleted and re-initialized. When a duplicate is found, or determined to be likely by the duplicate request checker, a replay rejection message is sent to the requesting client.

In the preferred implementation, every capability c is associated with a secret h(c, k), where k is a secret key shared by the metadata server and the block-device whose identifier is specified in c. A different key is used for each block-device. The use of this secret key is best explained by the example shown in FIG. 4. In FIG. 4, to access a file, a client 412 contacts the metadata server 402 with a file open request 408. If the file's metadata is not cached at the metadata server, the metadata server must retrieve it from the block-device 418, shown by dashed line 426.

Next, the metadata server checks if the client is permitted to access the file. If the client is permitted to access the file, the metadata server gives the client a block-device access package 410 containing the following: 1) a block map containing the list of physical blocks comprising the file, 2) a capability c for the files blocks, and 3) the secret s=h(c, k) associated with c. The metadata server's reply to the client is sent over a secure channel 414 (shown by a darker line in the figure) to prevent eavesdroppers from learning the secret needed to use the capability. A secure channel can be obtained by encrypting messages sent over the channel, for example under a block cipher using a session key established by an authentication protocol.

After receiving the capability c from the capability issuer 404, the client 412 issues a block access request 416 to the block-device using the capability that it obtained. More precisely, the client 412 sends to the block-device 418 an operation op that includes (1) the type of access (read or write); 2) the range of physical blocks to be accessed; and 3) in case of a write operation, the data to be written. Together with op, the client also sends the capability c provided by the metadata server and a MAC m=h(op, s), where s=h(c, k). Because m=h(op, s)=h(op, h(c, k)), this procedure is called the “double MAC”. The capability checker 420 can verify that the MAC is correct since it receives both c and op, and it has the secret key k. The verification procedure can be performed in two steps. First, the capability checker 420 computes m′=h(op, h(c, k)); then, it compares m′ to the m received from the client 412. If m≢m′, the block access request is rejected. Note that the double MAC serves a double purpose: 1) it provides proof that the client knows s and thus has been authorized to use the capability c to issue the operation op, and 2) it prevents op from being tampered with (i.e., after issuance by the client but before receipt by the block-device), because if an attacker changes op it would not know how to compute the required new MAC.

Once the block-device has successfully verified the client's block access request, it sends back a response resp together with h(resp, s) 424. Here resp contains data if the request is a read, or simply an acknowledgement if the request is a write. The client verifies that h(resp, s) was computed correctly, which prevents responses from being forged.

The disclosed block-based security mechanism using capability data provides at least four advantages. First, it prevents an unauthorized client who illegally gained access to the network from issuing malicious writes to the block-device to destroy the data on the block-device. Second, it prevents an authorized client who has legal access to the network from issuing malicious or erroneous writes to the data that it is not authorized to write, thereby destroying the data on the block-device. Third, the mechanism is independent of the policies used to control access to data, and therefore it is capable of supporting multiple operating systems and platforms. Fourth, since the capability checker is inserted between a network attached block-device's communication port and the computer network, the mechanism works with industry-standard network attached block-devices without having to modify the design of such block-devices.

One skilled in the relevant art will easily recognize that various modifications of the disclosure can work well for the disclosed network while preserving the spirit of the present invention. For example, a different scheme to authenticate messages, including digital signatures, can be used in place of messages authentication codes. Additional or different data structures may be used to implement the capability data and some of the data structures of the disclosed capability data may not be used.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for protecting data integrity in a network attached block-device in a network, comprising:
(a) receiving from a client a request to access data on the network attached block-device;
(b) determining if the client is permitted to access the requested data
(c) if the client is permitted to access the data, issuing a block-device access package containing capability data to the client over a secure channel, the capability data identifying a range of blocks in the network-attached block-device containing the data;
(d) at the network attached block-device, receiving a block access request from the client, the request including the capability data;
(e) at the network attached block-device, verifying that the block access request is consistent with the capability data; and
(f) if the block access request is verified, granting the block access request and executing the block access request at the network attached block-device.

2. The method claim 1, wherein the block access request includes a value that enables the block access request to be authenticated as having been sent by the client; and
the verifying includes authenticating the block access request as having been sent by the client.

3. The method claim 2, wherein the verifying includes verifying that a capability represented by the capability data has not been revoked.

4. The method claim 3, wherein the verifying includes verifying that the request is not a duplicate presentation of an earlier processed request.

5. The method claim 2, wherein the verifying includes verifying that the request is not a duplicate presentation of an earlier processed request.

6. The method claim 1, wherein the block access request includes a range of blocks in the network attached block-device to be accessed.

7. The method claim 1, wherein (a), (b) and (c) are performed by a metadata server, separate from the network attached block-device at which (d), (e) and (f) are performed.

8. The method claim 7, including establishing a common secret key shared by the metadata server and the network attached block-device;
wherein
the block-device access package includes a capability secret that is a function of the capability data and the common secret key; and
the block access request includes an operation secret that is a function of the block access request and the capability secret;
wherein the verifying includes recalculating the capability secret as a function of the capability data in the block access request and the common secret key, and computing a second operation secret as a function of the block access request and the recalculated capability secret, and then verifying that the second operation secret is consistent with the operation secret in the block access request.

9. The method of claim 8, wherein the capability secret and the operation secret are generated using a message authentication code (MAC) hash function.

10. The method of claim 8, wherein establishing a common secret key comprises:
starting the network attached block-device in a state in which it trusts a first party that communicates with it;
initiating a communication between the metadata server and the network attached block-device; and
negotiating the common secret key using a key exchange algorithm.

11. The method of claim 8, wherein the block-device access package further comprises:
a block map, wherein the block map comprises a list of physical blocks to be accessed; and
an access mode selected from the group consisting of read, write, and read-write.

12. The method of claim 8, wherein the block access request further comprises:
a list of physical blocks to be accessed;
an access mode selecting from the group consisting of read and write; and
the capability data.

13. The method of claim 1, wherein the capability data comprises:
a capability identification;
a group identification for indicating a group to which the capability data belongs;
a block-device identification for specifying the network attached block-device;
a list of extents for indicating ranges of physical blocks to which access is granted; and
an access mode for indicating a permitted mode of access.

14. The method of claim 1, wherein the network attached block-device is a first network attached block-device of a plurality of network attached block-devices, and the capability data comprises:
a capability identification;
a group identification for indicating a group to which the capability data belongs;
a block-device identification for specifying the first network attached block-device;
a list of extents for indicating ranges of physical blocks to which access is granted; and
an access mode for indicating a permitted mode of access.

15. A system for protecting data integrity in a network attached block-device in a network, comprising:
at least a metadata server having one or more processing units for executing computer programs, and having one or more network interfaces for exchanging information with devices coupled to the network;
at least a network attached block-device having one or more processing units for executing computer programs, and having one or more network interfaces for exchanging information with devices coupled to the network, wherein the network attached block-device stores data in a range of data blocks;
the metadata server including a capability issuer module, the capability issuer module including one or more computer programs containing instructions for:
receiving from a client a request to access data on the network attached block-device;
determining if the client is permitted to access the requested data;
if the client is permitted to access the data, issuing a block-device access package containing capability data to the client over a secure channel, the capability data identifying a range of blocks in the network attached block-device containing the data;
the network attached block-device including a capability checker module, the capability checker module including one or more computer programs containing instructions for:
receiving a block access request from the client, the request including the capability data;
verifying that the block access request is consistent with the capability data; and
if the block access request is verified, granting the block access request and executing the block access request at the network attached block-device.

16. The system of claim 15, wherein the block access request includes a value that enables the block access request to be authenticated as having been sent by the client; and
the verifying includes authenticating the block access request as having been sent by the client.

17. The system of claim 16, wherein the verifying includes verifying that a capability represented by the capability data has not been revoked.

18. The system of claim 17, wherein the verifying includes verifying that the request is not a duplicate presentation of an earlier processed request.

19. The system of claim 16, wherein the verifying includes verifying that the request is not a duplicate presentation of an earlier processed request.

20. The system of claim 15, wherein the block access request includes a range of blocks in the network attached block-device to be accessed.

21. The system of claim 15, wherein the metadata server and the network attached block-device are configured to establish a common secret key shared by the metadata server and the network attached block-device;
wherein
the block-device access package includes a capability secret that is a function of the capability data and the common secret key; and
the block access request includes an operation secret that is a function of the block access request and the capability secret;
wherein the verifying includes recalculating the capability secret as a function of the capability data in the block access request and the common secret key, and computing a second operation secret as a function of the block access request and the recalculated capability secret, and then verifying that the second operation secret is consistent with the operation secret in the block access request.

22. The system of claim 21, wherein a message authentication code (MAC) hash function is used for generating the capability secret and the operation secret.

23. The system of claim 21, wherein the system is configured to establish the common secret by:
starting the network attached block-device in a state in which it trusts a first party that communicates with it;
initiating a communication between the metadata server and the network attached block-device; and
negotiating the common secret key using a key exchange algorithm.

24. The system of claim 21, wherein the block-device access package further comprises:
a block map, wherein the block map comprises a list of physical blocks to be accessed; and
an access mode selecting from the group consisting of read, write, and read-write.

25. The system of claim 21, wherein the block access request further comprises:
a list of physical blocks to be accessed;
an access mode selecting from the group consisting of read and write; and
the capability data.

26. The system of claim 15, wherein the capability data comprises:
a capability identification;
a group identification for indicating a group to which the capability data belongs;
a block-device identification for specifying the network attached block-device;
a list of extents for indicating ranges of physical blocks to which access is granted; and
an access mode for indicating a permitted mode of access.

27. The system of claim 15, wherein the network attached block-device is a first network attached block-device of a plurality of network attached block-devices, and the capability data comprises:
a capability identification;
a group identification for indicating a group to which the capability data belongs;
a block-device identification for specifying the first network attached block-device;
a list of extents for indicating ranges of physical blocks to which access is granted; and
an access mode for indicating a permitted mode of access.

28. A computer program product, comprising a medium storing computer programs for execution by one or more computer systems, the computer program comprising:
a capability issuer module, for use in conjunction with a metadata server, the capability issuer module including one or more computer programs containing instructions for:
receiving from a client a request to access data on a network attached device in a network;
determining if the client is permitted to access the requested data;
if the client is permitted to access the data, issuing a block-device access package containing capability data to the client over a secure channel, the capability data identifying a range of blocks in the network attached block-device containing the data;
a capability checker module for use in conjunction with a network attached block-device, the capability checker module including one or more computer programs containing instructions for:
receiving a block access request from the client, the request including the capability data;
verifying that the block access request is consistent with the capability data; and
if the block access request is verified, granting the block access request and executing the block access request at the network attached block-device.

29. The computer program product of claim 28, wherein the block access request includes a value that enables the block access request to be authenticated as having been sent by the client; and
the verifying includes authenticating the block access request as having been sent by the client.

30. The computer program product of claim 29, wherein the verifying includes verifying that a capability represented by the capability data has not been revoked.

31. The computer program product of claim 30, wherein the verifying includes verifying that the request is not a duplicate presentation of an earlier processed request.

32. The computer program product of claim 29, wherein the verifying includes verifying that the request is not a duplicate presentation of an earlier processed request.

33. The computer program product of claim 28, wherein the block access request includes a range of blocks in the network attached block-device to be accessed.

34. The computer program product of claim 28, wherein the metadata server and the network attached block-device are configured to establish a common secret key shared by the metadata server and the network attached block-device;
wherein
the block-device access package includes a capability secret that is a function of the capability data and the common secret key; and
the block access request includes an operation secret that is a function of the block access request and the capability secret;
wherein the verifying includes recalculating the capability secret as a function of the capability data in the block access request and the common secret key, and computing a second operation secret as a function of the block access request and the recalculated capability secret, and then verifying that the second operation secret is consistent with the operation secret in the block access request.

35. The computer program product of claim 34, wherein a message authentication code (MAC) hash function is used for generating the capability secret and the operation secret.

36. The computer program product of claim 34, wherein the system in configured to establish the common secret by:
starting the network attached block-device in a state in which it trusts a first party that communicates with it;
initiating a communication between the metadata server and the network attached block-device; and
negotiating the common secret key using a key exchange algorithm.

37. The computer program product of claim 34, wherein the block-device access package further comprises:
a block map, wherein the block map comprises a list of physical blocks to be accessed; and
an access mode selecting from the group consisting of read, write, and read-write.

38. The computer program product of claim 34, wherein the block access request further comprises:
a list of physical blocks to be accessed;
an access mode selecting from the group consisting of read and write; and
the capability data.

39. The computer program product of claim 28, wherein the capability data comprises:
a capability identification;
a group identification for indicating a group to which the capability data belongs;
a block-device identification for specifying the network attached block-device;
a list of extents for indicating ranges of physical blocks to which access is granted; and
an access mode for indicating a permitted mode of access.

40. The computer program product of claim 28, wherein the network attached block-device is a first network attached block-device of a plurality of network attached block-devices, and the capability data comprises:
a capability identification;
a group identification for indicating a group to which the capability data belongs;
a block-device identification for specifying the first network attached block-device;
a list of extents for indicating ranges of physical blocks to which access is granted; and
an access mode for indicating a permitted mode of access.
